(19) United States
(12) Patent Application Publication
(10) Pub. No.: US 2025/0245548 A1
(43) Pub. Date: Jul. 31, 2025

(54) SYSTEM AND METHOD FOR MODEL TRAINING IN ENHANCED PRIVACY ENVIRONMENTS

(71) Applicant: Yahoo Ad Tech LLC, New York, NY (US)

(72) Inventors: Naama Haramaty-Krasne, Kfar-Yehoshua (IL); Oren S. Somekh, Kfar-Netter (IL); Yohay Kaplan, Haifa (IL)

(21) Appl. No.: 18/423,462

(22) Filed: Jan. 26, 2024

(51) Int. Cl. G06N 20/00

(52) U.S. Cl. CPC G06N 20/00

(57) ABSTRACT

In an example, sets of event information associated with events may be identified. The events may include conversion events. The conversion events may comprise attributed and un-attributed conversion events, as well as aggregated conversion events. Machine learning model training may be performed, using a training set of attributable and un-attributable conversion events and a privacy bias in connection with the un-attributable conversion events, to generate a first machine learning model. Further machine learning model training may be performed, using the aggregated conversion events to generate a second machine learning model. Conversion probabilities associated with content items may be determined using the first and second machine learning models. Attributable content items may be selected for presentation via a client device based upon the conversion probabilities.

### BACKGROUND

Many publishers of digital content provide various digital platforms for viewing their content—platforms such as websites, social media applications, mail applications, mobile apps, etc. Such publisher platforms may provide opportunities for publishers to request third parties, such as advertisers, to bid on the use of portions of their platform display (e.g., portions of publisher webpages, user interfaces, screens, etc.) to display third party digital content along with the publisher's content, such as advertisements, media, video, etc. Such publisher platforms also present opportunities for third parties, such as advertisers, to potentially display their content to a wide audience, and such third parties may wish to bid on one or more rights to utilize the publisher's display portions for displaying the third-party content.

Content serving platforms may provide real time bidding auctions where publishers may request that third parties bid on opportunities to utilize portions of the publisher's display, and third parties may bid on such requests, and where the content of the winning bid may be served to the publisher's display portion. As such, the bid values used in the auction process are of great importance. Often, such bid values may be based in part on the predicted conversion probabilities—probabilities that the content items involved in the bid may be converted by an end user to a tangible result for the third party—a result such as making a purchase, signing up for a service, downloading an article, etc.

Often, however, increased or enhanced privacy restrictions on conversion data gathering results in conversion probability models and conversion probability predictions that are hindered or less accurate than they otherwise might be because of less attribution data relating to conversion events being available to train conversion probability prediction models.

### SUMMARY

In accordance with the present disclosure, one or more systems and/or methods are provided. In an example, in connection with a content serving system, a first plurality of sets of event information associated with a first plurality of conversion events is identified. The first plurality of sets of event information may comprise a second plurality of sets of event information, a third plurality of sets of event information, and a fourth plurality of sets of event information. The second plurality of sets of event information may be associated with a plurality of attributable conversion events of the first plurality of events. The third plurality of sets of event information may be associated with a plurality of un-attributable conversion events of the first plurality of events. The fourth plurality of sets of event information may be associated with a plurality of aggregated conversion events of the first plurality of events.

Machine learning model training may be performed, using the second plurality of sets of event information and the third plurality of sets of event information, to generate a first machine learning model. The training may use a privacy bias in connection with the third plurality of sets of event information. A first request for content associated with a client device is received by a content serving system. Responsive to receiving the first request, a first plurality of associated conversion probabilities are determined, for a first plurality of content items, using the first machine learning model. In some embodiments, the first plurality of content items may comprise only attributable content items. A first content item from the first plurality of content items is selected for presentation via the client device, based upon the first plurality of associated conversion probabilities.

Further machine learning training may be performed using the fourth plurality of sets of event information and a first plurality of aggregation labels associated with the fourth plurality of events to generate a second machine learning model. A second request for content associated with a client device is received by the content serving system. Responsive to receiving the second request, a second plurality of associated conversion probabilities are determined, for a second plurality of content items, using the second machine learning model. In some embodiments, the first plurality of content items may comprise only attributable content items. A first content item from the second plurality of content items is selected for presentation via the client device, based upon the second plurality of associated conversion probabilities.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for determining conversion probabilities associated with content items and/or selecting content for transmission to devices in an enhanced privacy environment, in accordance with one or more embodiments set forth herein

FIG. 5 is a component block diagram illustrating an example system for determining conversion probabilities associated with content items and/or selecting content for transmission to devices in an enhanced privacy environment, in accordance with one or more embodiments set forth herein.

FIG. 6A is a component block diagram illustrating an example system for determining conversion probabilities associated with content items and/or selecting content for transmission to devices in an enhanced privacy environment, where a machine learning training module performs machine learning model training to generate a first machine learning model.

FIG. 6B is a component block diagram illustrating example training data of an example system for determining conversion probabilities associated with content items and/or selecting content in an enhanced privacy environment for transmission to devices.

FIG. 6C is a component block diagram illustrating an example system for determining conversion probabilities associated with content items and/or selecting content in an enhanced privacy environment for transmission to devices.

FIG. 7 is a flow chart illustrating an example method for determining conversion probabilities associated with content items and/or selecting content for transmission to devices in an enhanced privacy environment, in accordance with one or more embodiments set forth herein.

FIG. 8A is a component block diagram illustrating an example system for determining conversion probabilities associated with content items and/or selecting content for transmission to devices in an enhanced privacy environment, where a machine learning training module performs machine learning model training to generate a second machine learning model.

FIG. 8B is a component block diagram illustrating example training data of an example system for determining conversion probabilities associated with content items and/or selecting content in an enhanced privacy environment for transmission to devices.

FIG. 8C is a component block diagram illustrating an example system for determining conversion probabilities associated with content items and/or selecting content in an enhanced privacy environment for transmission to devices.

FIG. 9 is an illustration of a scenario featuring an example non-transitory machine-readable medium in accordance with one or more embodiments set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

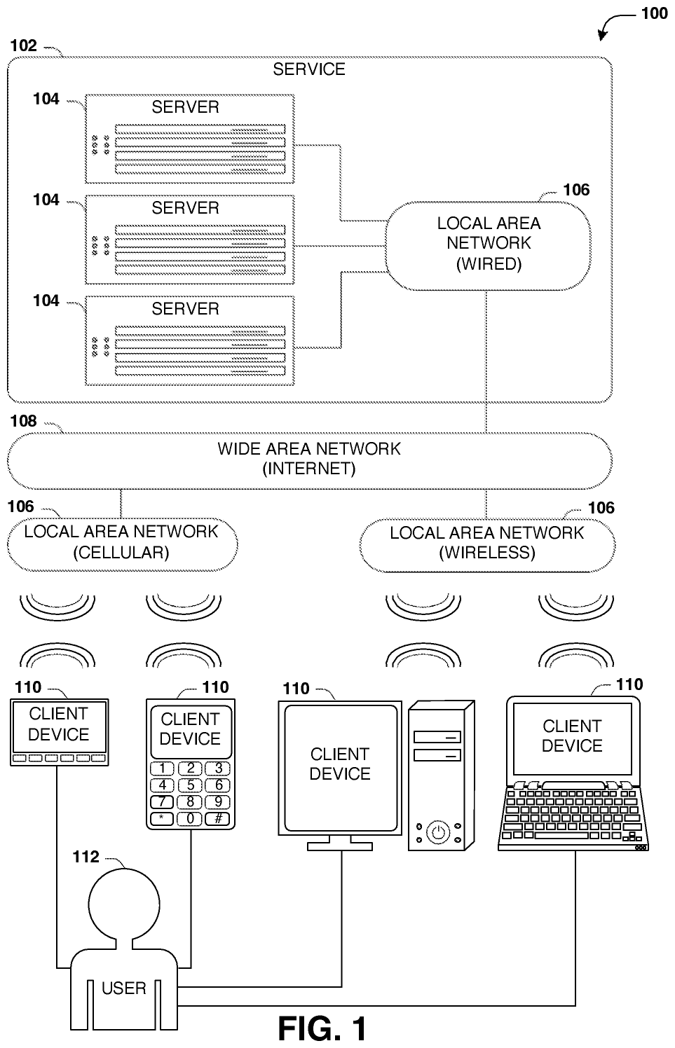

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP)). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ different architectures, may be compliant or compatible with differing protocols and/or may interoperate within the local area network 106. Additionally, a variety of local area networks 106 may be interconnected; e.g., a router may provide a link between otherwise separate and independent local area networks 106.

In scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

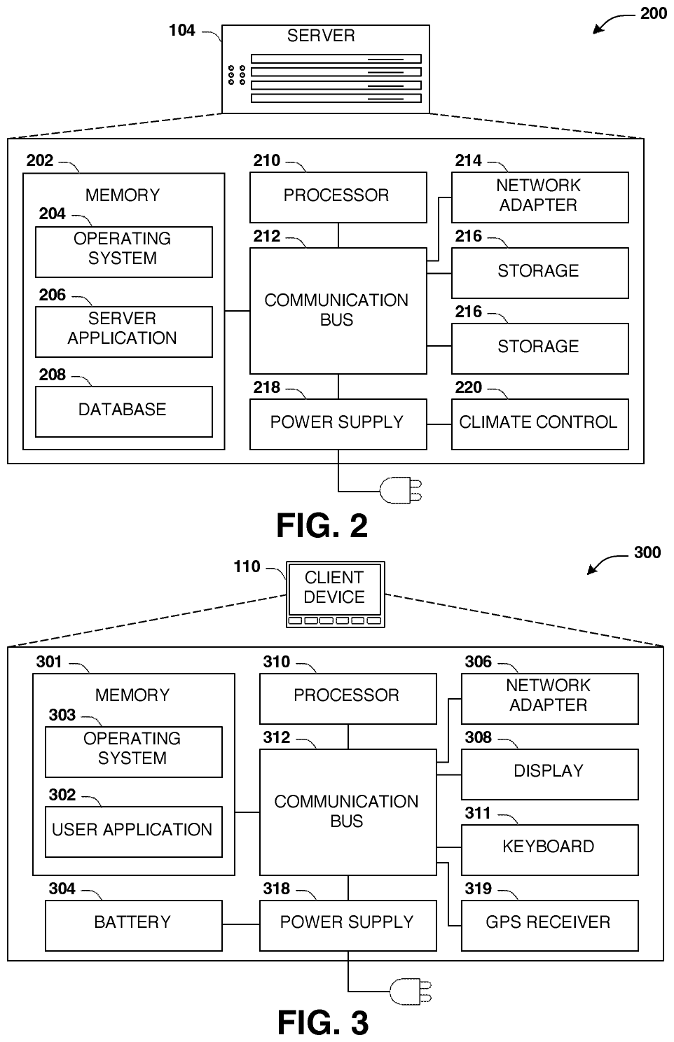

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic architecture diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

### 2. Presented Techniques

One or more systems and methods for determining conversion probabilities associated with content items and/or selecting content for transmission to devices in environments having enhanced privacy measures are provided.

For example, a first user (and/or a first client device associated with the first user) may access and/or interact with a service, such as a browser, software, a website, an application, an operating system, etc. that provides a platform for viewing and/or downloading content from a server associated with a content serving system/platform. In some examples, in response to receiving a request for content associated with the first client device, the content serving system may determine conversion probabilities associated with a plurality of content items (e.g., advertisements, images, links, videos, etc.) that are hosted, stored or accessed by the system. The conversion probabilities may be used to select a content item, from the plurality of content items, for presentation via the first client device.

In general, as mentioned, selecting content items by some content serving systems, such as those involved in the systems and methods disclosed herein, may involve determining conversion probabilities, otherwise referred to as predictions of conversion rates (pCVRs), for individual content items served by the content serving system. A conversion event may be understood to be a user taking a predefined action (often predefined by an advertiser) after either clicking on the content (post-click conversions) or viewing the content (post-view conversions). As used herein, unless context dictates otherwise, the term “conversion” and “conversion event” may be understood to refer to only post-click conversions. In general, the predefined action may be any relevant action as defined in the context of the system. In some embodiments, the predefined action occurs on, and/or is reflected in data of, an advertiser's system (e.g., website, service, etc.), and/or another third-party system, associated with the content that was clicked on—e.g., purchasing a product, adding a product to a cart, signing a form, installing an app, etc.

In general, content producers (e.g., advertisers) may be interested in bidding against other content producers for the right to have a content serving system, such as those involved in the systems and methods disclosed herein, serve their content items to users (or user devices). Such bidding may be based on the likelihood that a user's interaction with a served content item will result in a conversion (e.g., purchase of a product or service associated with the content item, adding product associated with content item to a cart, signing a form, installing an app., etc.), and consequently it is useful to have accurate pCVR models to calculate accurate conversion probabilities for content items. Such models may be trained on conversion events that are linked or otherwise attributed to particular clicks on particular content items. Since the data needed to link or attribute a conversion event (a predefined conversion event) with a particular click event may often reside on an advertiser or third party's systems, content serving systems or platforms may be impacted in their ability to train accurate conversion probability models by increased privacy restrictions inhibiting the sharing of attribution information with them. As such, there is a need for such content serving systems to adapt to such increased privacy restrictions.

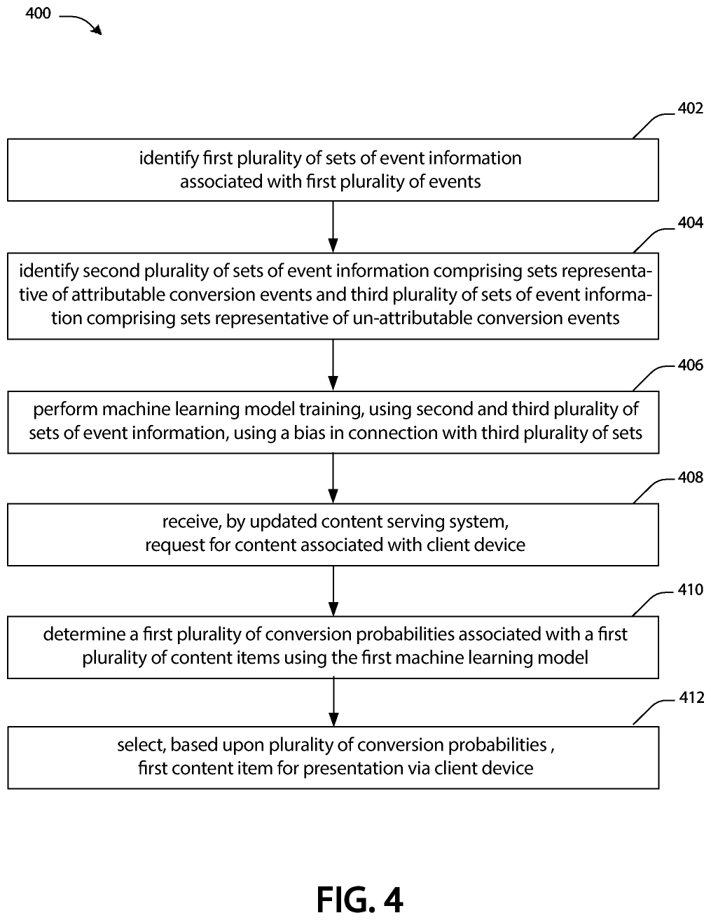

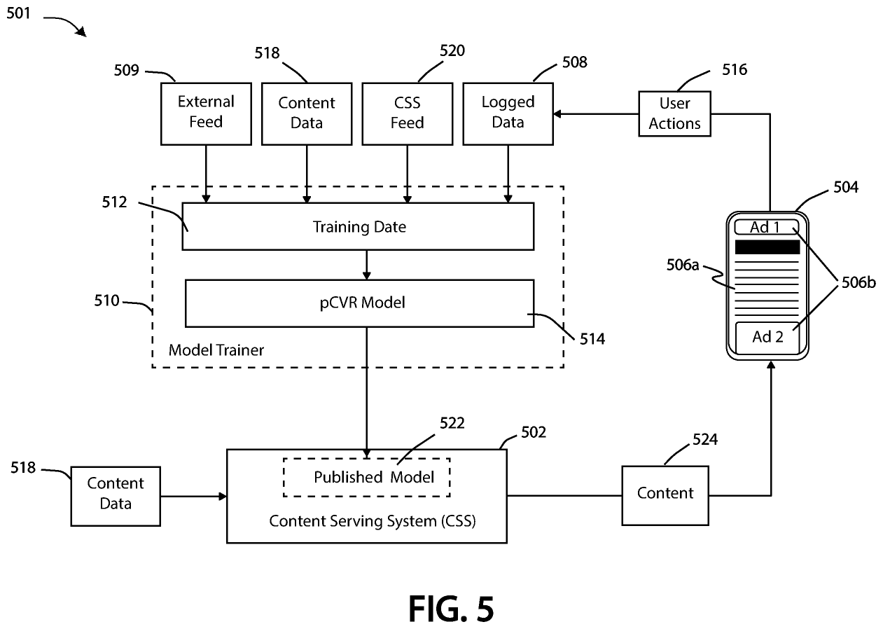

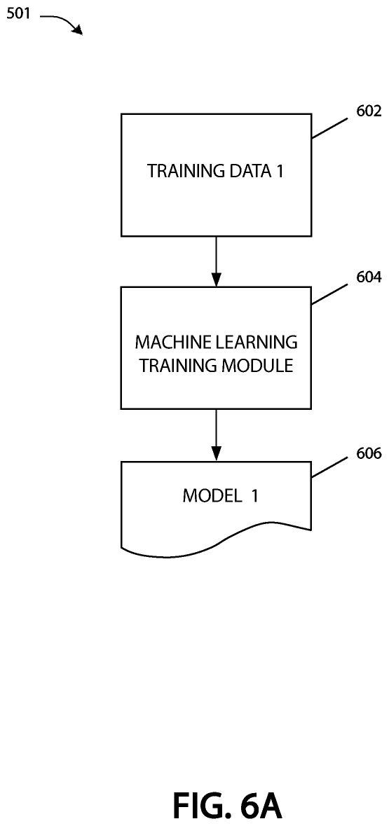

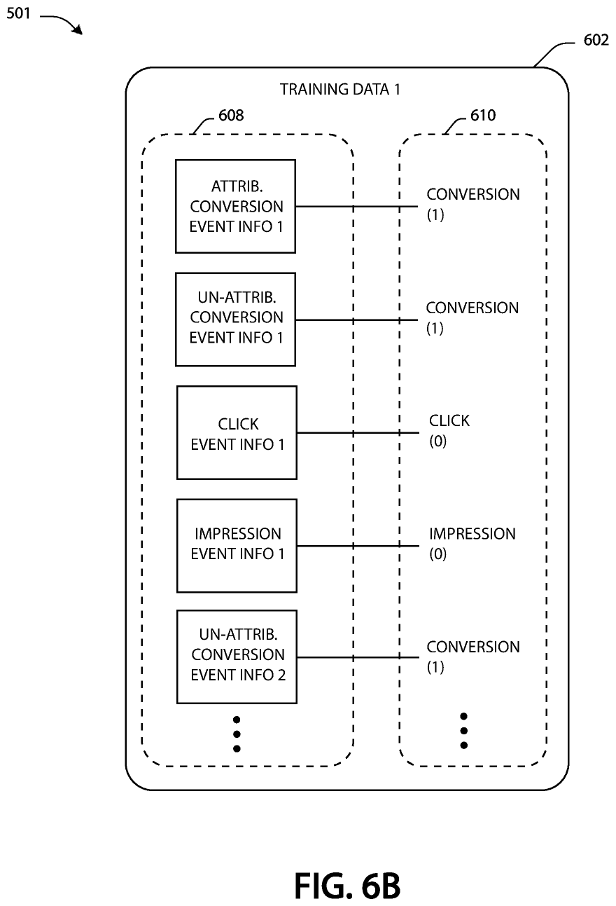

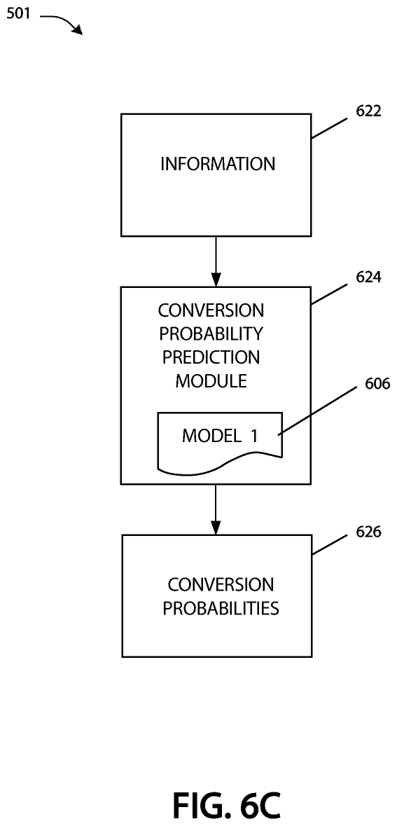

Embodiments for determining conversion probabilities associated with content items and/or selecting content for transmission to devices in environments having enhanced privacy measures are illustrated below with reference to example method 400 of FIG. 4, as described in conjunction with system 501 of FIGS. 5 and 6.

In general, a content serving system, such as content serving system 502, may serve users with content items which may be displayed through a publisher's display or medium displayed on computing devices, such as client mobile device 504. It may be noted that, for the sake of clarity and ease of reference, the description to follow may only reference one type of content item (advertisements) and one type of publisher/publisher medium (website/webpage), but the embodiments of the systems and methods herein should be understood to include generally any type of digital content (e.g., articles, videos, advertisements, images, links, etc.) and publisher medium (e.g., website, web application, text messages, notifications, social network feeds, mobile app screens, other user interfaces, etc.) sufficient to provide the functionality described herein.

In some embodiments, when a user of a client computing device, such as client device 504, accesses a publisher's webpage 506 displayed on client device 504, for which the content serving system 502 is enabled, the content serving system 502 may receive one or more calls or requests for content to display in relation to the publisher's displayed content. For example, in responding to a request (e.g., browser request), in some embodiments a publisher's web server may be configured to retrieve content items served by content serving platform 502 (or references to such items (e.g., URLs)), by making one or more calls or requests for content items, to incorporate into the webpage (e.g., page 506) that it serves to its client device's web browser, which displays the digital content items as part of the webpage, as represented by slots 506b displayed on webpage 506 alongside publisher's content 506a. In other embodiments, the publisher's web server may provide functionality in the content it serves to its client device (e.g., ad tags) that allows the web browser to make one or more calls or requests for digital content items served by content serving platform 502, to display as part of the webpage.

At 402, a first plurality of sets of event information associated with a first plurality of events may be identified. In general, an event of the first plurality of events may comprise any event relating to content serving platforms (e.g., system 501), sufficient to provide the functionality described herein. For example, in some embodiments the first plurality of events may comprise conversion events. In some embodiments, the first plurality of events may include impression-related events—events associated with a presentation of a content item via a client device (e.g., an ad impression event), wherein the content item may be presented via the client device in response to a request for content. For example, in some embodiments, the first plurality of events may include one or more types of click events, view events, conversion events, etc. In general, a click event may occur whenever a user responds to an impression by clicking a displayed content item (e.g., an advertisement). In general, a view event may occur whenever a user otherwise interacts with a displayed content item (e.g., starts a video).

Generally, conversion events may be understood to be a user taking a predefined action (often predefined by an advertiser) after either clicking on the content (post-click conversions) or viewing the content (post-view conversions). As used herein, unless context dictates otherwise, the term “conversion” and “conversion event” may be understood to refer to only post-click conversions. In addition, to qualify as a conversion event, the predefined event generally must occur within a predefined window of time (predefined by, e.g., the content provider, advertiser) after the user has clicked on the content in question. Unlike clicks, which usually come within seconds after a user sees a content item, a conversion event may come within hours or even days after a click.

In general, a content serving platform (e.g., system 501) may be able to obtain certain basic information concerning a served content item from the nature of serving the item—information such as, e.g., the identity of the content item, information concerning the destination (e.g., publisher) and end use or user, impression-related interaction, etc. Such information typically may be characterized as data concerning impression and click events, and similar events relating to the content item, and may be logged and stored by the content serving platform (e.g., by logged data module 508). Conversion events, however, may occur primarily on content providers' systems (e.g., advertisers' web servers), and as such, the content serving platform may frequently rely on an external feed (by, e.g., the advertiser's system, event handlers or code, server-side trackers, etc.), such as that shown at feed 509 in FIG. 5, for data relating to conversion events.

Some content providers, such as some advertisers, may be interested in enhancing their bidding strategy to achieve more conversions and/or otherwise tailoring or understanding the context of conversion of their content items. Likewise, providers of content serving platforms may generally be interested in assisting content providers to achieve more conversions on their content items and/or to otherwise tailor or understand the context of conversions of content items served by their platform. Accordingly, in some embodiments, content providers may provide certain data or information concerning conversion events of their content items to content serving systems or platforms by, e.g., providing an external feed of such information. As noted, increased privacy considerations (technical or legal/regulatory) may impact this dynamic, resulting in limited conversion event information sharing (e.g. aggregated conversion event information) or no such conversion event information sharing (e.g., resulting in un-attributable conversion events), and the systems and methods described herein may assist in successfully dealing with such privacy considerations.

In some embodiments, in particular, content providers may share attribution information relating to conversion events with content serving platforms. Attribution information may comprise generally any information sufficient to tie, associate, or otherwise attribute a conversion event with an impression-related event of a content item (e.g., a click, impression, etc. of a content item). In other embodiments, content serving platforms may receive attribution information from one or more other sources than the content provider. Regardless of source, in general, any conversion events for which such attribution information is available to the content serving platform may be referenced herein as an attributable conversion event. Conversely, in general, any conversion event for which such attribution information is not available may be referenced herein as an un-attributable conversion event.

At 404, in some embodiments, a second plurality of sets of event information (of the first plurality of sets of event information) associated with a second plurality of events comprising a plurality of attributable conversion events (of the first plurality of events) may be identified. In some embodiments, a third plurality of sets of event information (of the first plurality of sets of event information) associated with a third plurality of events comprising a plurality of un-attributable conversion events (of the first plurality of events) may be identified.

At 406, in some embodiments, machine learning model training may be performed using a first training data set to generate the first machine learning model. In general, the machine learning models and training of those models in the systems and methods herein may be any type sufficient to provide the functionality herein. In some examples, the machine learning models and training of those models may be generally any suitable for addressing the recommender problem. In some embodiments, the machine learning model and training may be a latent factor model of a collaborative-filtering based event prediction algorithm, updated on batches of test data using stochastic or online gradient descent-based learning. FIG. 6A illustrates a machine learning training module 604 performing machine learning model training to generate the first machine learning model (shown with reference number 606 in FIG. 6A). In an example, the first training data set (shown with reference number 602 in FIG. 6A) may be input to the machine learning training module 604. The machine learning training module 604 may generate the first machine learning model 606 using the first training data set 602.

In general, in some embodiments, the first training data set 602 may comprise the first plurality of sets of event information associated with the first plurality of events. In some embodiments, the first training data set 602 may comprise the second plurality of sets of event information associated with the second plurality of events comprising the plurality of attributable conversion events of the first plurality of events and/or the third plurality of sets of event information associated with the third plurality of events comprising the plurality of un-attributable conversion events of the first plurality of events. In some embodiments, first training data set 602 may comprise a fifth plurality of sets of event information associated with one or more impression-related events (e.g., click events, impressions, etc.) associated with the second plurality of events and/or with the third plurality of events.

FIG. 6B illustrates an example of the first training data set 602. In some examples, the first training data set 602 may comprise a first plurality of sets of training data 608 and/or first target information 610 (e.g., target attributes associated with the first plurality of sets of training data 608). The first plurality of sets of training data 608 may comprise the second plurality of sets of event information and/or the third plurality of sets of event information and/or the fifth plurality of sets of event information. For example, a first subset of the plurality of sets of training data 608 may comprise the second plurality of sets of event information and/or a second subset of the plurality of sets of training data 608 may comprise the third plurality of sets of event information and/or a third subset of the plurality of sets of training data 608 may comprise the fifth plurality of sets of event information (e.g., each set of training data of the first subset may comprise a set of event information of the second plurality of sets of event information and/or each set of training data of the second subset may comprise a set of event information of the third plurality of sets of event information and/or each set of training data of the third subset may comprise a set of event information of the fifth plurality of sets of event information).

In some examples, the first target information 610 may comprise a first plurality of labels. The first plurality of labels may comprise a second plurality of labels associated with the second plurality of sets of event information and/or third plurality of sets of event information (e.g., the first and/or second subset). The first plurality of labels may comprise a third plurality of labels associated with the fifth plurality of sets of event information (e.g., the third subset). In some examples, the first plurality of labels may be indicative of classifications. In some examples, the second plurality of labels, that are associated with the second and/or third plurality of sets of event information, may be indicative of a first classification (e.g., a classification corresponding to conversion events) and/or a first value (e.g., 1). Alternatively, and/or additionally, the third plurality of labels, that are associated with the fifth plurality of sets of event information, may be indicative of a second classification (e.g., a classification corresponding to impression-related events) and/or a second value (e.g., 0).

In some embodiments, to illustrate as shown in FIG. 6B, a label of the second plurality of labels (shown as “CONVERSION (1)” in FIG. 6B) may be associated with one or more sets of event information (shown as “ATTRIB. CONVERSION EVENT INFO” and/or “UN-ATTRIB. CONVERSION EVENT INFO 1” and “UN-ATTRIB. CONVERSION EVENT INFO 2” in FIG. 6B) of the second and/or third plurality of sets of event information associated with the second and/or third plurality of conversion events. A label of the third plurality of labels (shown as “CLICK (0)” and/or “IMPRESSION (0)” in FIG. 6B) may be associated with sets of event information (shown as “CLICK EVENT INFO 1” and/or “IMPRESSION EVENT INFO 1” in FIG. 6B) of the fifth plurality of sets of event information associated with one or more click events, impression events, etc. associated with a second plurality of events comprising a plurality of attributable conversion events of the first plurality of events and/or with a third plurality of events comprising a plurality of un-attributable conversion events of the first plurality of events.

In some examples, the second and/or third plurality of sets of event information associated with the second and/or third plurality of conversion events may be labeled as corresponding to positive events. Alternatively, and/or additionally, the fifth plurality of sets of event information may be labeled as corresponding to negative events. For example, a value (e.g., 0) indicated by the third plurality of labels may be lower than a value (e.g., 1) indicated by the second plurality of labels.

In one or more embodiments, the machine learning model training module of the systems and methods herein (e.g., training module 604) may utilize and/or incorporate a privacy bias, p, in connection with the third plurality of sets of event information associated with a third plurality of events comprising a plurality of un-attributable conversion events of the first plurality of events. In general, the machine learning model training module may process training data sets (e.g., training data set 602 in FIG. 6B) in any suitable manner that incorporates a privacy bias in relation to its processing of un-attributable events and/or un-attributable event information (e.g., set of information shown as “UN-ATTRIB. CONVERSION EVENT INFO 1” and “UN-ATTRIB. CONVERSION EVENT INFO 2” in FIG. 6B) sufficient to provide the functionality described and provided herein. For example, in some embodiments, in which pCVRs may be computed as functions of user and content item interaction vectors, privacy bias, p, may be implemented as a common user vector (e.g., an identity vector) used during training in computing interaction vectors for any content item in a training set that comprises an un-attributable conversion event. In other embodiments, privacy bias, p, may comprise a common parameter that is added as a bias parameter to any pCVR associated with a content item in a training set that comprises an un-attributable conversion event.

At 408, a first request for content associated with a first client device may be received. In some examples, the first request for content may be associated with a first internet resource (e.g., a webpage (webpage 504), an application, a mobile application, etc.). For example, the first request for content may be a request to be provided with a content item (e.g., an advertisement, an image, a link, a video, etc.) for presentation via the first client device (e.g., client device 502) on the first internet resource.

In some examples, one or more features associated with the first request for content may be determined. The one or more features may comprise client information associated with the first client device and/or internet resource information associated with the first internet resource. Determining the first plurality of conversion probabilities using the first machine learning model may be based upon the one or more features. In some examples, a conversion probability may be determined based upon the client information associated with the first client device, content item information associated with the first content item and/or the internet resource information associated with the first internet resource.

In an example, the content item information may be indicative of at least one of a content item, a content item identifier that identifies the content item, a brand, advertiser and/or company associated with the content item, one or more topics of the content item, one or more products and/or services associated with the content item (e.g., the content item may be used to advertise and/or promote the one or more products and/or the one or more services), a format of the content item (indicative of whether the content item is audio, video or an image, for example), a duration and/or size of the content item, etc.

In an example, the first client information may be indicative of at least one of the first client device, a first device identifier associated with the first client device, a first IP address associated with the first client device, a first MAC address associated with the first client device, a first carrier identifier indicative of first carrier information associated with the first client device, a first user identifier (e.g., at least one of a username, an email address, a user account identifier, etc.) associated with the first client device and/or the first user, a first browser cookie (and/or a first cookie identifier associated with the first client device), first activity information (e.g., search history information, website browsing history, email information, etc.) associated with the first client device, the first user identifier and/or the first user, first user demographic information (e.g., age, gender, etc.) associated with the first client device, the first user identifier and/or the first user, first location information associated with the first client device, the first user identifier and/or the first user, etc.

In an example, the first internet resource information may be indicative of at least one of the first internet resource, a first internet resource identifier associated with the first internet resource, a first host device associated with the first internet resource (e.g., the first host device may comprise one or more computing devices, storage and/or a network configured to host the first internet resource), a first host identifier of the first host device, a first domain (e.g., a domain name, a top-level domain, etc.) associated with the first internet resource, a first application identifier associated with the first internet resource (e.g., an application), a first publisher identifier associated with a first publisher of the first internet resource, etc.

At 410, a first plurality of conversion probabilities associated with a first plurality of content items may be determined using the first machine learning model. In some examples, the first plurality of conversion probabilities may be determined in response to receiving the first request for content. The first plurality of conversion probabilities may comprise a first conversion probability associated with a first content item (e.g., an advertisement, an image, a link, a video, etc.) of the first plurality of content items. In some examples, the first conversion probability is representative of (e.g., comprises) a probability of receiving a conversion of the first content item responsive to presenting the first content item via the first client device (e.g., a probability that presentation of the first content item via the first client device would be followed by a selection, such as a click, of the first content item on the first client device and thereafter by a predefined conversion event resulting from the click).

FIG. 6C illustrates the first conversion probability of the first plurality of conversion probabilities associated with a first plurality of content items (shown with reference number 626 in FIG. 6C) being determined using the first machine learning model 606. In an example, the first machine learning model 606 may be loaded into a conversion probability prediction module 624 (which itself may be part of a model trainer, such as model trainer 510 in FIG. 5). Information 622 may be input to the conversion probability prediction module 624. In general, information 622 may comprise any information sufficient to provide the functionality described herein. In some examples, information 622 may comprise first content item information, first client information and/or first internet resource information. The conversion probability prediction module 624 may use the first machine learning model 606 to determine the first conversion probability 626 based upon information 622. In some embodiments, conversion probabilities, other than the first conversion probability, of the first plurality of conversion probabilities may be determined using one or more of the techniques discussed herein with respect to determining the first conversion probability associated with the first content item, such that each of the first plurality of conversion probabilities is associated with a content item from the first plurality of content items.

In some embodiments herein, the first plurality of content items may comprise a second plurality of content items comprising a plurality of attributable content items and a third plurality of content items comprising a plurality of un-attributable content items. In general, an attributable content item may comprise any content item for which, at the time of service in response to a request for content, the system may predict with a reasonable degree of confidence that the content item will be capable of being attributed to a conversion event if one were to occur. In some embodiments, a reasonable degree of confidence may comprise 75%; in some embodiments 85%; in some embodiments 95%. Also, in general, an un-attributable content item may comprise any content item that is not an attributable content item. In some embodiments herein, the first plurality of content items may comprise a fourth plurality of content items comprising a plurality of attributable content items and comprising no un-attributable content items. In one or more embodiments, the second plurality of content items may comprise the fourth plurality of content items.

At 412 a first content item of the first plurality of content items is selected for presentation via the first client device, based upon the first plurality of conversion probabilities. In some embodiments, a bidding process associated with the first request for content may be performed to select a content item from the first plurality of content items that are participating in an auction (e.g., an auction for selection of a content item to present via the first client device 504). In some examples, the first plurality of content items participating in the auction may comprise the second plurality of content items; in some embodiments, the fourth plurality of content items. In some embodiments, the first plurality of content items participating in the auction may comprise the first content item.

In some embodiments, the bidding process comprises determining a content score (i.e., bid value) associated with each of the first plurality of content items participating in the auction. In some embodiments, the bidding process comprises determining a first content score associated with the first content item. In some embodiments, each of the content scores (e.g., including the first content score) participating in the auction may be determined based upon at least one of a budget associated with each of the content items, a target audience associated with each of the content items, one or more advertisement campaign goals associated with each of the content items, a content item bid value associated with each of the content items, etc. (e.g., based upon at least one of a budget associated with the first content item, a target audience associated with the first content item, one or more advertisement campaign goals associated with the first content item, a content item bid value associated with the first content item, etc.).

Alternatively, and/or additionally, a content score associated with each of the first plurality of content items participating in the auction may be determined based upon a cost-per-action parameter. In general, a cost-per-action parameter may comprise a price for a given action or event (e.g., a conversion) that may be set and/or determined manually or algorithmically, and referenced generally hereinafter as CPA. In one or more embodiments, the cost per action parameter may be set and/or predefined by a content provider (e.g., advertiser), and may be referenced hereinafter as target cost-per-action, or tCPA. In one or more embodiments, the cost per action parameter may be determined algorithmically by the system (e.g., system 501) based on sampling actual cost-per-action values determined for content items served by the system (to, e.g., one or more client devices) during a portion of a predefined content campaign (e.g. ad campaign). In some embodiments, the sampled portion may comprise the first 30% of a campaign; in some embodiments, the first 20%; in some embodiments, the first 10%. Such cost-per-action parameters may be referenced hereinafter as measured cost-per-action, or mCPA. In one or more embodiments, the cost per action parameter may be determined algorithmically by the system (e.g., system 501) based on sampling actual cost-per-action values determined for content items served by the system (to, e.g., one or more client devices) to a targeted and predefined subset of users (known as the “seed” audience) of a larger set of users (known as the potential audience) during a portion of a predefined content campaign (e.g. ad campaign). Such cost-per-action parameters may be referenced hereinafter as seed cost-per-action, or seed CPA.

Alternatively, and/or additionally, a content score associated with each of the first plurality of content items participating in the auction may be determined based upon the product of a conversion probability associated with the content item multiplied by a CPA parameter associated with the content item. In one or more embodiments, a CPA bid type may be associated with a content item of the plurality of content items, wherein a CPA bid type comprises an oCPC bid type, an eCPC bid type, and/or an R&P bid type. Additionally, and/or alternatively, in some embodiments, a content score for a content item of an oCPC bid type may be determined based on the product of a conversion probability associated with the content item multiplied by a tCPA associated with the content item. Additionally, and/or alternatively, in some embodiments, a content score for a content item of an eCPC bid type may be determined based on the product of a conversion probability associated with the content item multiplied by a mCPA associated with the content item. Additionally, and/or alternatively, in some embodiments, a content score for a content item of an R&P bid type may be determined based on the product of a conversion probability associated with the content item multiplied by a seed CPA associated with the content item.

In some examples, the first plurality of content items participating in the auction may comprise the second plurality of content items, and a content score associated with each of the second plurality of content items may be determined based upon the product of a conversion probability associated with the content item multiplied by a CPA parameter associated with the content item. In some examples, the first plurality of content items participating in the auction may comprise the fourth plurality of content items, and a content score associated with each of the fourth plurality of content items may be determined based upon the product of a conversion probability associated with the content item multiplied by a CPA parameter associated with the content item.

In some examples, in response to selecting the first content item for presentation via the first client device 504, the first content item may be transmitted to the first client device 504 for presentation (e.g., via the webpage 506). For example, the content serving system 502 may provide the first content item to be presented via the webpage 506 while the webpage 506 is accessed by the first client device 504.

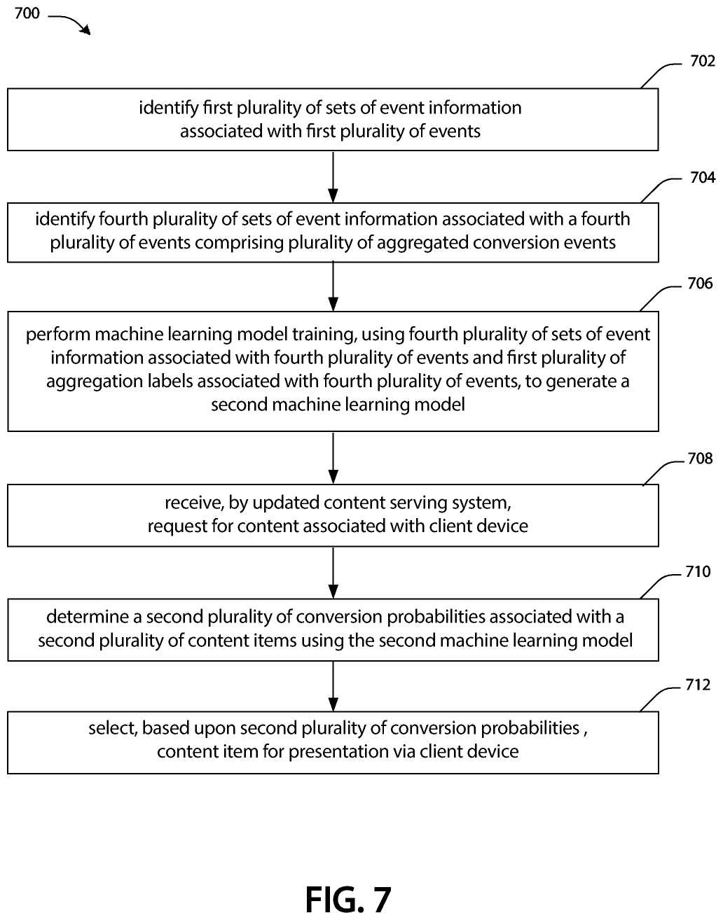

FIG. 5 illustrates an example of a system 501 for determining conversion probabilities associated with content items and/or selecting content for transmission to devices, in an enhanced privacy environment, described with respect to the methods 400 and 700 of FIGS. 4 and 7, respectively. A logging system 508 may receive information 516 indicative of user actions from one or more client devices 504 and/or one or more computers (e.g., servers associated with internet resources accessed by the one or more client devices 504). For example, the information 516 may be indicative of user activity associated with events of the first plurality of events. The logging system 508 may be configured to log information associated with the user activity. A content data system 515 may be configured to store content items and content-item related information. A content serving system feed 522 may be configured to provide data relating to content service (e.g., impression-related event information, etc.). In some examples, the logging system 508, content data system 518, and/or content serving system 502 (via feed 520) may provide and/or generate the first plurality of sets of event information associated with the first plurality of events and/or training data 512 to a machine learning training module/system 510. The machine learning training system 510 may be configured to use the training data 512 to train a conversion probability prediction model 514, such as the first and second models 606, 806. In some examples, the training data 512 may comprise the first plurality of sets of event information. In some examples, the conversion probability prediction model 514 may be used to generate conversion probabilities (e.g., first plurality of conversion probabilities 626 and/or second plurality of conversion probabilities 826). In some examples, model data 522 of the conversion probability model 514 may be loaded into a content serving system 502 (e.g., an advertisement serving system). In some examples, content data (e.g., advertisement data) may be received by the content serving system 502 from the content data system/store 518 (e.g., an advertisement inventory), such as a data store that stores content items (e.g., advertisements) and/or information (e.g., content item information) associated with the content items. In some examples, the content serving system 502 may use the conversion probability prediction model 522 to determine conversion probabilities associated with presenting content items via client devices. For example, the content serving system 502 may select content items for presentation via client devices based upon the conversion probabilities determined using the conversion probability prediction model 522. The content serving system 502 may transmit content 524 (e.g., one or more rendered content items, such as one or more rendered advertisements) to one or more client devices 504, such as in response to selecting the one or more content items for presentation via the one or more client devices 504.

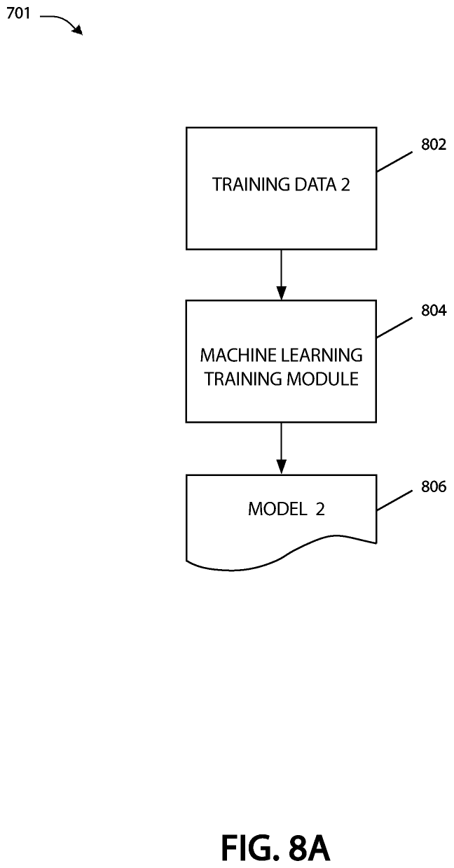

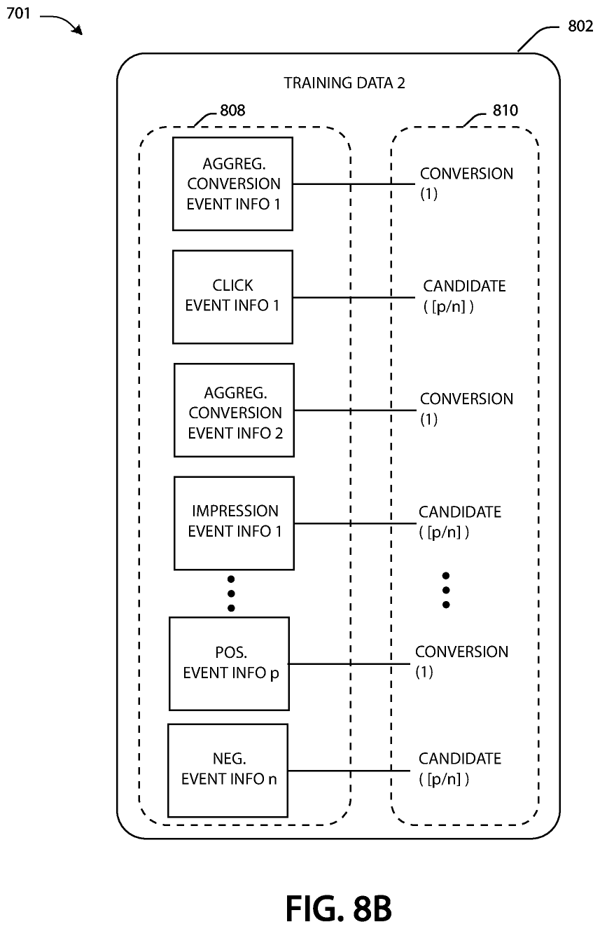

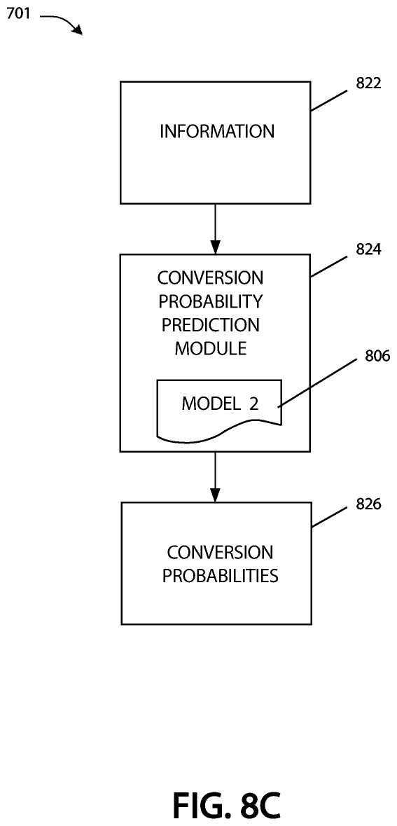

Additional embodiments for determining conversion probabilities associated with content items and/or selecting content for transmission to devices in environments having enhanced privacy measures are further illustrated by example method 700 of FIG. 7, as described in conjunction with systems 501, 701 of FIGS. 5 and 8.

At 702, a first plurality of sets of event information associated with a first plurality of events may be identified. In general, as described above, an event of the first plurality of events may comprise any event relating to content serving platforms, sufficient to provide the functionality described herein. For example, in some embodiments the first plurality of events may comprise conversion events. In some embodiments, the first plurality of events may comprise impression-related events—events associated with a presentation of a content item via a client device (e.g., an ad impression event), wherein the content item may be presented via the client device in response to a request for content. For example, in some embodiments, the first plurality of events may include one or more types of click events, view events, conversion events, etc. In general, a click event may occur whenever a user responds to an impression by clicking a displayed content item (e.g., an advertisement). In general, a view event may occur whenever a user interacts with a displayed content item (e.g., starts a video).

At 704, in some embodiments, a fourth plurality of sets of event information (of the first plurality of sets of event information) associated with a fourth plurality of events comprising a plurality of aggregated conversion events (of the first plurality of events) may be identified. In general, aggregated conversion events refers to one or more of a set of conversion events that are not individually attributable to a specific user and/or content item, but that collectively have attribution information as a set. For example, in some embodiments, aggregated conversion events may comprise conversion attribution information collectively identifying conversion events (e.g., simply identifying the number of conversions events, etc.) from a single advertisement campaign and/or for a single advertiser for a finite time period. In some embodiments, the plurality of aggregated conversion events may comprise events that are capable of being classified as either positive events or negative events, as discussed below in relation to FIG. 8B.

At 706, in some embodiments, machine learning model training may be performed using a second training data set to generate a second machine learning model. FIG. 8A illustrates a machine learning training module 804 performing machine learning model training to generate the second machine learning model (shown with reference number 806 in FIG. 8A). In an example, the second training data set (shown with reference number 802 in FIG. 8A) may be input to the machine learning training module 804. The machine learning training module 804 may generate the second machine learning model 806 using the second training data set 802.

In general, in some embodiments, the second training data set 802 may comprise the first plurality of sets of event information associated with the first plurality of events. In some embodiments, the second training data set 802 may comprise the fourth plurality of sets of event information associated with the fourth plurality of events comprising the plurality of aggregated conversion events of the first plurality of events. In some embodiments, second training data set 802 may comprise a sixth plurality of sets of event information that are associated with one or more candidate events—events that are not aggregated conversion events (e.g., events that are impression-related events—click events, impressions, etc.) but that may be associated with the aggregated conversion events of the fourth plurality of events. Such association may be, for example, being events that the system (e.g., system. 701) may determine or set as being related to at least one of the aggregated conversion events. Such relatedness may be, for example, being a source of at least one aggregated conversion event (such as by, e.g., being the click event leading to at least one of the aggregated conversion events).

FIG. 8B illustrates an example of the second training data set 802. In some examples, the second training data set 802 may comprise a second plurality of sets of training data 808 and/or second target information 810 (e.g., target attributes associated with the second plurality of sets of training data 808). The second plurality of sets of training data 808 may comprise the fourth plurality of sets of event information and/or sixth plurality of sets of event information. For example, a first subset of the plurality of sets of training data 808 may comprise the fourth plurality of sets of event information and/or a second subset of the plurality of sets of training data 808 may comprise the sixth plurality of sets of event information (e.g., each set of training data of the first subset may comprise a set of event information of the fourth plurality of sets of event information and/or each set of training data of the second subset may comprise a set of event information of the sixth plurality of sets of event information).

In some examples, the first target information 810 may comprise a first plurality of aggregation labels. The first plurality of aggregation labels may comprise a second plurality of aggregation labels associated with the fourth plurality of sets of event information (e.g., the first subset). The first plurality of aggregation labels may comprise a third plurality of aggregation labels associated with the sixth plurality of sets of event information (e.g., the second subset). In some examples, the first plurality of aggregation labels may be indicative of classifications. In some examples, the second plurality of aggregation labels, that are associated with the fourth plurality of sets of event information, may be indicative of a first classification (e.g., a classification corresponding to aggregated conversion events) and/or a first value (e.g., 1). Alternatively, and/or additionally, the third plurality of aggregation labels, that are associated with the sixth plurality of sets of event information, may be indicative of a second classification (e.g., a classification corresponding to impression-related events) and/or a second value (e.g., the ratio p/n, described below).

In one or more embodiments, for a given training set, each of the sets of event information in the fourth plurality of sets of event information that is associated with an aggregated conversion event may be labeled as corresponding to a positive event, and such event labels may be referred to herein as positive aggregation labels. Alternatively, and/or additionally, each of the sets of event information in the sixth plurality of sets of event information that is associated with a candidate event may be labeled as corresponding to a negative event, and such event labels may be referred to herein as negative aggregation labels.

In some embodiments, for a given training set (e.g., second training set 802), the system (e.g., system 701) may assign to each of the plurality of candidate events in the training set, a negative aggregation label value equal to the ratio, p/n, where “p” equals the number of aggregated conversion events in the training set, and “n” equals the number of candidate events in the training set, and may assign to each of the plurality of aggregate conversion events in the training set, a positive aggregation label value that is a numeric value greater than the value, p/n. In one or more embodiments, the negative aggregation label value may be set equal to the ratio, p/n, and wherein the ratio, p/n, is between 0 and 1, and the positive aggregation label value may be set equal to 1.

In some embodiments, to illustrate as shown in FIG. 8B, a label of the second plurality of aggregation labels (shown as “CONVERSION (1)” in FIG. 8B) may be associated with one or more sets of event information (shown as “AGGREG. CONVERSION EVENT INFO” in FIG. 8B) of the fourth plurality of sets of event information associated with the fourth plurality of aggregated conversion events. A label of the third plurality of labels (shown as “CANDIDATE ([p/n])” in FIG. 8B) may be associated with sets of event information (shown as “CLICK EVENT INFO” and/or “IMPRESSION EVENT INFO” in FIG. 8B) of the sixth plurality of sets of event information associated with one or more click events, impression events, etc. associated with a fourth plurality of events comprising a plurality of aggregate conversion events of the first plurality of events.

At 708, a second request for content associated with a second client device may be received. In some embodiments, the second request for content may be associated with a second internet resource (e.g., a web page, an application, a mobile application, etc.). For example, the second request for content may be a request to be provided with a content item (e.g., an advertisement, an image, a link, a video, etc.) for presentation via the second client device on the second internet resource. In some embodiments, the second client device is the first client device and/or the second internet resource is the first internet resource.

In some embodiments, one or more features associated with the second request for content may be determined. The one or more features may comprise client information associated with the second client device and/or internet resource information associated with the second internet resource. Determining a second plurality of conversion probabilities using the second machine learning model may be based upon the one or more features. In some examples, a conversion probability may be determined based upon the client information associated with the second client device, content item information associated with the content item and/or the internet resource information associated with the second internet resource.

In an example, the content item information may be indicative of at least one of the content item, a content item identifier that identifies the content item, a brand, advertiser and/or company associated with the content item, one or more topics of the content item, one or more products and/or services associated with the content item (e.g., the content item may be used to advertise and/or promote the one or more products and/or the one or more services), a format of the content item (indicative of whether the content item is audio, video or an image, for example), a duration and/or size of the content item, etc.

In an example, the second client information may be indicative of at least one of the second client device, a second device identifier associated with the second client device, a second IP address associated with the second client device, a second MAC address associated with the second client device, a second carrier identifier indicative of second carrier information associated with the second client device, a second user identifier (e.g., at least one of a username, an email address, a user account identifier, etc.) associated with the second client device and/or the second user, a second browser cookie (and/or a second cookie identifier associated with the second client device), second activity information (e.g., search history information, website browsing history, email information, etc.) associated with the second client device, the second user identifier and/or the second user, second user demographic information (e.g., age, gender, etc.) associated with the second client device, the second user identifier and/or the second user, second location information associated with the second client device, the second user identifier and/or the second user, etc.

In an example, the second internet resource information may be indicative of at least one of the second internet resource, a second internet resource identifier associated with the second internet resource, a second host device associated with the second internet resource (e.g., the second host device may comprise one or more computing devices, storage and/or a network configured to host the second internet resource), a second host identifier of the second host device, a second domain (e.g., a domain name, a top-level domain, etc.) associated with the second internet resource, a second application identifier associated with the second internet resource (e.g., an application), a second publisher identifier associated with a second publisher of the second internet resource, etc.

At 710, a second plurality of conversion probabilities associated with a second plurality of content items may be determined using the second machine learning model. In some examples, the second plurality of conversion probabilities may be determined in response to receiving the second request for content. The second plurality of conversion probabilities may comprise a first conversion probability associated with a first content item (e.g., an advertisement, an image, a link, a video, etc.) of the second plurality of content items. In some examples, the first conversion probability is representative of (e.g., comprises) a probability of receiving a conversion of the first content item responsive to presenting the first content item via the second client device (e.g., a probability that presentation of the first content item via the second client device would be followed by a selection, such as a click, of the first content item on the second client device and thereafter by a predefined conversion event resulting from the click).

FIG. 8C illustrates the first conversion probability of the second plurality of conversion probabilities associated with the second plurality of content items (shown with reference number 826 in FIG. 8C) being determined using the second machine learning model 806. In an example, the second machine learning model 806 may be loaded into a conversion probability prediction module 824. Information 822 may be input to the conversion probability prediction module 824. In general, information 822 may comprise any information sufficient to provide the functionality described herein. In some examples, information 822 may comprise content item information (of the first content item of the second plurality of content items), second client information and/or second internet resource information. The conversion probability prediction module 824 may use the second machine learning model 806 to determine the first conversion probability (of the second plurality of conversion probabilities) 826 based upon information 822. In some embodiments, conversion probabilities other than the first conversion probability of the second plurality of conversion probabilities, may be determined using one or more of the techniques discussed herein with respect to determining the first conversion probability associated with the first content item of the second plurality of content items, such that each of the first plurality of conversion probabilities is associated with a content item from the second plurality of content items.

At 712 a first content item of the second plurality of content items is selected for presentation via the second client device, based upon the second plurality of conversion probabilities. In some embodiments, a bidding process associated with the second request for content may be performed to select a content item from the second plurality of content items that are participating in an auction (e.g., an auction for selection of a content item to present via the first client device 504). In some embodiments, the first plurality of content items participating in the auction may comprise the first content item of the second plurality of content items.

In some embodiments, the bidding process comprises determining a content score (i.e., bid value) associated with each of the second plurality of content items participating in the auction. In some embodiments, the bidding process comprises determining a first content score associated with the first content item. In some embodiments, each of the content scores (e.g., including the first content score) participating in the auction may be determined based upon at least one of a budget associated with each of the content items, a target audience associated with each of the content items, one or more advertisement campaign goals associated with each of the content items, a content item bid value associated with each of the content items, etc. (e.g., based upon at least one of a budget associated with the first content item, a target audience associated with the first content item, one or more advertisement campaign goals associated with the first content item, a content item bid value associated with the first content item, etc.).

Alternatively, and/or additionally, a content score associated with each of the second plurality of content items participating in the auction may be determined based upon a cost-per-action parameter. In general, a cost-per-action parameter may comprise a price for a given action or event (e.g., a conversion) that may be set and/or determined manually or algorithmically, and referenced generally hereinafter as CPA. In one or more embodiments, the cost per action parameter may be a tCPA parameter; in some embodiments, an mCPA parameter; in some embodiments, a seed CPA parameter.

Alternatively, and/or additionally, a content score associated with each of the second plurality of content items participating in the auction may be determined based upon the product of a conversion probability associated with the content item multiplied by a CPA parameter associated with the content item. In one or more embodiments, a CPA bid type may be associated with a content item of the plurality of content items, wherein a CPA bid type comprises an oCPC bid type, an eCPC bid type, and/or an R&P bid type. Additionally, and/or alternatively, in some embodiments, a content score for a content item of an oCPC bid type may be determined based on the product of a conversion probability associated with the content item multiplied by a tCPA associated with the content item. Additionally, and/or alternatively, in some embodiments, a content score for a content item of an eCPC bid type may be determined based on the product of a conversion probability associated with the content item multiplied by a mCPA associated with the content item. Additionally, and/or alternatively, in some embodiments, a content score for a content item of an R&P bid type may be determined based on the product of a conversion probability associated with the content item multiplied by a seed CPA associated with the content item.

In some examples, in response to selecting the first content item for presentation via the second client device, the first content item may be transmitted to the second client device for presentation (e.g., via a webpage loaded on the second client device).

Although various examples of the present disclosure are described with respect to selection and/or presentation of content items comprising advertisements, embodiments are contemplated in which the content items comprise any type of content, such as at least one of search results, audio (e.g., songs, podcasts, etc.), video (e.g., movies, shows, video clips, etc.), articles, social media feeds, suggested content (e.g., links to videos, audio, articles, social media feeds, etc.), etc. while staying within the scope of the present disclosure.

Implementation of at least some of the disclosed subject matter may lead to benefits including, but not limited to, more accurate determination of conversion probabilities associated with content items in an enhanced privacy environment (e.g., as a result of training models using both attributable and un-attributable conversion event information with a privacy bias in relation to the un-attributable conversion events, as a result of training models using aggregated conversion event information and aggregate labels that apportion the positive weight of the aggregate conversation events over the negative impression-related events that are associated with the aggregate events, determining the conversion probabilities based upon either or both types of trained models, etc.). The more accurate determination of conversion probabilities may also lead to a more accurate and/or appropriate selection of a content item for presentation via a client device that has a higher probability of resulting in the content item being selected and/or a higher probability of a user consuming the content item to have an interest in the content item.

Alternatively, and/or additionally, implementation of at least some of the disclosed subject matter may lead to benefits including an increase in generalized revenue for presenting content items via client devices (e.g., as a result of the more accurate determination of conversion probabilities, etc.).

Alternatively, and/or additionally, implementation of at least some of the disclosed subject matter may lead to a more accurate and/or appropriate selection of a content item for presentation via a client device that has a higher probability of resulting in the content item being selected and/or a higher probability of a user consuming the content item to have an interest in the content item (e.g., as a result of the more accurate determination of conversion probabilities, etc.).

Alternatively, and/or additionally, implementation of at least some of the disclosed subject matter may lead to benefits including a reduction in screen space and/or an improved usability of a display (e.g., of the client device) (e.g., as a result of the higher probability of the user consuming the content item to have an interest in the content item, wherein the user may not view content that the user does not have an interest in, wherein the user may not need to open a separate application and/or a separate window in order to find content having the subject matter that the user has an interest in, etc.).

Alternatively, and/or additionally, implementation of at least some of the disclosed subject matter may lead to benefits including a reduction in bandwidth (e.g., as a result of reducing a need for the user to open a separate application and/or a separate window in order to search throughout the internet and/or navigate through internet content to find content that the user has an interest in).

In some examples, at least some of the disclosed subject matter may be implemented on a client device, and in some examples, at least some of the disclosed subject matter may be implemented on a server (e.g., hosting a service accessible via a network, such as the Internet).

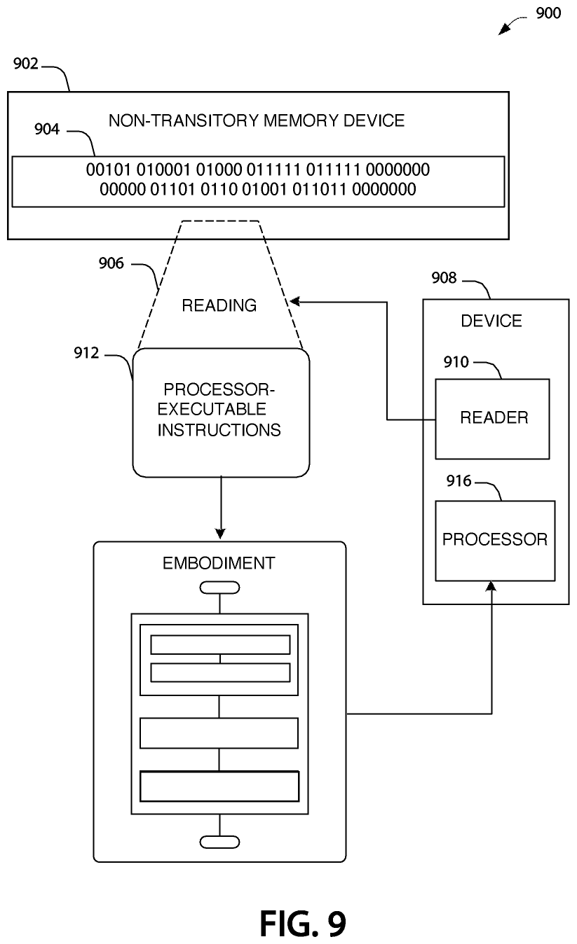

FIG. 9 is an illustration of a scenario 900 involving an example non-transitory machine readable medium 902. The non-transitory machine readable medium 902 may comprise processor-executable instructions 912 that when executed by a processor 916 cause performance (e.g., by the processor 916) of at least some of the provisions herein. The non-transitory machine readable medium 902 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 902 stores computer-readable data 904 that, when subjected to reading 906 by a reader 910 of a device 908 (e.g., a read head of a hard disk drive, or a read operation invoked on a solid-state storage device), express the processor-executable instructions 912. In some embodiments, the processor-executable instructions 912, when executed cause performance of operations, such as at least some of the example method 400 of FIG. 4, for example. In some embodiments, the processor-executable instructions 912 are configured to cause implementation of a system, such as at least some of the example system 501 of FIG. 5, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
identifying a first plurality of sets of event information associated with a first plurality of events, wherein the first plurality of sets of event information comprises:
a second plurality of sets of event information associated with a second plurality of events comprising a plurality of attributable conversion events of the first plurality of events; and
a third plurality of sets of event information associated with a third plurality of events comprising a plurality of un-attributable conversion events of the first plurality of events;
performing machine learning model training, using the second plurality of sets of event information associated with the second plurality of events and the third plurality of sets of event information associated with the third plurality of events, to generate a first machine learning model, wherein the machine learning model training uses a privacy bias in connection with the third plurality of sets of event information;
receiving a first request for content associated with a first client device;
responsive to receiving the first request for content, determining a first plurality of conversion probabilities associated with a first plurality of content items using the first machine learning model; and
selecting, based upon the first plurality of conversion probabilities, a first content item of the first plurality of content items for presentation via the first client device.

2. The method of claim 1 wherein the first plurality of content items comprises a plurality of attributable content items and a plurality of un-attributable content items, and wherein the selecting, based upon the first plurality of conversion probabilities, comprises:
determining a first plurality of content scores for the plurality of attributable content items by
identifying, for each attributable content item of the plurality of attributable content items, a cost-per-action parameter associated with the attributable content item,
identifying, for each attributable content item of the plurality of attributable content items, a conversion probability from the first plurality of conversion probabilities associated with the attributable content item, and
calculating, for each attributable content item of the plurality of attributable content items, a content score based on a product obtained by multiplying the identified cost-per-action parameter associated with the attributable content item with the identified conversion probability associated with the attributable content item;
comparing the first plurality of content scores; and
selecting the first content item from the first plurality of content items, wherein the first content item is associated with the highest content score of the first plurality of content scores.

3. The method of claim 1 wherein the first plurality of sets of event information comprises a fourth plurality of sets of event information associated with a fourth plurality of events comprising a plurality of aggregated conversion events of the first plurality of events, and further comprising:
performing machine learning model training using the fourth plurality of sets of event information associated with fourth plurality of events and a first plurality of aggregation labels associated with the fourth plurality of events to generate a second machine learning model;
receiving a second request for content associated with a second client device;
responsive to receiving the second request for content, determining a second plurality of conversion probabilities associated with a second plurality of content items using the second machine learning model; and
selecting, based upon the second plurality of conversion probabilities, a first content item of the second plurality of content items for presentation via the second client device.

4. The method of claim 3 wherein the first plurality of aggregation labels comprises a plurality of positive aggregation labels and a plurality of negative aggregation labels, and further comprising:
performing machine learning model training using the set of positive aggregation labels and the set of negative aggregation labels, and using a training data set comprising a first plurality of training sets of event information associated with a plurality of aggregated conversion events of the fourth plurality of events and a second plurality of training sets of event information associated with a plurality of candidate events associated with the plurality of aggregated conversion events.

5. The method of claim 3 wherein the selecting, based upon the second plurality of conversion probabilities, comprises:
determining a second plurality of content scores for the second plurality of content items by
identifying, for each content item of the second plurality of content items, a cost-per-action parameter associated with the content item,
identifying, for each content item of the second plurality of content items, a conversion probability from the second plurality of conversion probabilities associated with the content item, and
calculating, for each content item of the second plurality of content items, a content score based on a product obtained by multiplying the identified cost-per-action parameter associated with the content item with the identified conversion probability associated with the content item;
comparing the second plurality of content scores; and
selecting the first content item from the second plurality of content items, wherein the first content item is associated with the highest content score of the second plurality of content scores.

6. The method of claim 3 wherein the second client device is the first client device.

7. The method of claim 4, wherein each of the set of positive aggregation labels comprises a value equal to one and wherein each of the set of negative aggregation labels comprises a value equal to the ratio of the number of aggregated conversion events divided by the number candidate events.

8. A computing device comprising: a processor; and memory comprising processor-executable instructions that when executed by the processor cause performance of operations, the operations comprising:
identifying a first plurality of sets of event information associated with a first plurality of events, wherein the first plurality of sets of event information comprises:
a second plurality of sets of event information associated with a second plurality of events comprising a plurality of attributable conversion events of the first plurality of events; and
a third plurality of sets of event information associated with a third plurality of events comprising a plurality of un-attributable conversion events of the first plurality of events;
performing machine learning model training, using the second plurality of sets of event information associated with the second plurality of events and the third plurality of sets of event information associated with the third plurality of events, to generate a first machine learning model, wherein the machine learning model training uses a privacy bias in connection with the third plurality of sets of event information;
receiving a first request for content associated with a first client device;
responsive to receiving the first request for content, determining a first plurality of conversion probabilities associated with a first plurality of content items using the first machine learning model; and
selecting, based upon the first plurality of conversion probabilities, a first content item of the first plurality of content items for presentation via the first client device.

9. The computing device of claim 8 wherein the first plurality of content items comprises a plurality of attributable content items and a plurality of un-attributable content items, and wherein the selecting, based upon the first plurality of conversion probabilities, comprises:
determining a first plurality of content scores for the plurality of attributable content items by
identifying, for each attributable content item of the plurality of attributable content items, a cost-per-action parameter associated with the attributable content item,
identifying, for each attributable content item of the plurality of attributable content items, a conversion probability from the first plurality of conversion probabilities associated with the attributable content item, and
calculating, for each attributable content item of the plurality of attributable content items, a content score based on a product obtained by multiplying the identified cost-per-action parameter associated with the attributable content item with the identified conversion probability associated with the attributable content item;
comparing the first plurality of content scores; and
selecting the first content item from the first plurality of content items, wherein the first content item is associated with the highest content score of the first plurality of content scores.

10. The computing device of claim 8 wherein the first plurality of sets of event information comprises a fourth plurality of sets of event information associated with a fourth plurality of events comprising a plurality of aggregated conversion events of the first plurality of events, and further comprising:
performing machine learning model training using the fourth plurality of sets of event information associated with fourth plurality of events and a first plurality of aggregation labels associated with the fourth plurality of events to generate a second machine learning model;
receiving a second request for content associated with a second client device;
responsive to receiving the second request for content, determining a second plurality of conversion probabilities associated with a second plurality of content items using the second machine learning model; and
selecting, based upon the second plurality of conversion probabilities, a first content item of the second plurality of content items for presentation via the second client device.

11. The computing device of claim 10 wherein the first plurality of aggregation labels comprises a plurality of positive aggregation labels and a plurality of negative aggregation labels, and further comprising:
performing machine learning model training using the set of positive aggregation labels and the set of negative aggregation labels, and using a training data set comprising a first plurality of training sets of event information associated with a plurality of aggregated conversion events of the fourth plurality of events and a second plurality of training sets of event information associated with a plurality of candidate events associated with the plurality of aggregated conversion events.

12. The computing device of claim 10 wherein the selecting, based upon the second plurality of conversion probabilities, comprises:
determining a second plurality of content scores for the second plurality of content items by
identifying, for each content item of the second plurality of content items, a cost-per-action parameter associated with the content item,
identifying, for each content item of the second plurality of content items, a conversion probability from the second plurality of conversion probabilities associated with the content item, and
calculating, for each content item of the second plurality of content items, a content score based on a product obtained by multiplying the identified cost-per-action parameter associated with the content item with the identified conversion probability associated with the content item;
comparing the second plurality of content scores; and
selecting the first content item from the second plurality of content items, wherein the first content item is associated with the highest content score of the second plurality of content scores.

13. The computing device of claim 10 wherein the second client device is the first client device.

14. The computing device of claim 11, wherein each of the set of positive aggregation labels comprises a value equal to one and wherein each of the set of negative aggregation labels comprises a value equal to the ratio of the number of aggregated conversion events divided by the number candidate events.

15. A non-transitory machine-readable medium having stored thereon processor-executable instructions that when executed cause performance of operations, the operations comprising:
identifying a first plurality of sets of event information associated with a first plurality of events, wherein the first plurality of sets of event information comprises:
a second plurality of sets of event information associated with a second plurality of events comprising a plurality of attributable conversion events of the first plurality of events; and
a third plurality of sets of event information associated with a third plurality of events comprising a plurality of un-attributable conversion events of the first plurality of events;
performing machine learning model training, using the second plurality of sets of event information associated with the second plurality of events and the third plurality of sets of event information associated with the third plurality of events, to generate a first machine learning model, wherein the machine learning model training uses a privacy bias in connection with the third plurality of sets of event information;
receiving a first request for content associated with a first client device;
responsive to receiving the first request for content, determining a first plurality of conversion probabilities associated with a first plurality of content items using the first machine learning model; and
selecting, based upon the first plurality of conversion probabilities, a first content item of the first plurality of content items for presentation via the first client device.

16. The non-transitory machine-readable medium of claim 15 wherein the first plurality of content items comprises a plurality of attributable content items and a plurality of un-attributable content items, and wherein the selecting, based upon the first plurality of conversion probabilities, comprises:
determining a first plurality of content scores for the plurality of attributable content items by
identifying, for each attributable content item of the plurality of attributable content items, a cost-per-action parameter associated with the attributable content item,
identifying, for each attributable content item of the plurality of attributable content items, a conversion probability from the first plurality of conversion probabilities associated with the attributable content item, and
calculating, for each attributable content item of the plurality of attributable content items, a content score based on a product obtained by multiplying the identified cost-per-action parameter associated with the attributable content item with the identified conversion probability associated with the attributable content item;
comparing the first plurality of content scores; and
selecting the first content item from the first plurality of content items, wherein the first content item is associated with the highest content score of the first plurality of content scores.

17. The non-transitory machine-readable medium of claim 15 wherein the first plurality of sets of event information comprises a fourth plurality of sets of event information associated with a fourth plurality of events comprising a plurality of aggregated conversion events of the first plurality of events, and further comprising:
performing machine learning model training using the fourth plurality of sets of event information associated with fourth plurality of events and a first plurality of aggregation labels associated with the fourth plurality of events to generate a second machine learning model;
receiving a second request for content associated with a second client device;
responsive to receiving the second request for content, determining a second plurality of conversion probabilities associated with a second plurality of content items using the second machine learning model; and
selecting, based upon the second plurality of conversion probabilities, a first content item of the second plurality of content items for presentation via the second client device.

18. The non-transitory machine-readable medium of claim 17 wherein the first plurality of aggregation labels comprises a plurality of positive aggregation labels and a plurality of negative aggregation labels, and further comprising:
performing machine learning model training using the set of positive aggregation labels and the set of negative aggregation labels, and using a training data set comprising a first plurality of training sets of event information associated with a plurality of aggregated conversion events of the fourth plurality of events and a second plurality of training sets of event information associated with a plurality of candidate events associated with the plurality of aggregated conversion events.

19. The non-transitory machine-readable medium of claim 17 wherein the selecting, based upon the second plurality of conversion probabilities, comprises:
determining a second plurality of content scores for the second plurality of content items by
identifying, for each content item of the second plurality of content items, a cost-per-action parameter associated with the content item,
identifying, for each content item of the second plurality of content items, a conversion probability from the second plurality of conversion probabilities associated with the content item, and
calculating, for each content item of the second plurality of content items, a content score based on a product obtained by multiplying the identified cost-per-action parameter associated with the content item with the identified conversion probability associated with the content item;
comparing the second plurality of content scores; and
selecting the first content item from the second plurality of content items, wherein the first content item is associated with the highest content score of the second plurality of content scores.

20. The non-transitory machine-readable medium of claim 18, wherein each of the set of positive aggregation labels comprises a value equal to one and wherein each of the set of negative aggregation labels comprises a value equal to the ratio of the number of aggregated conversion events divided by the number candidate events.
